(19) United States
(12) Patent Application Publication
(10) Pub. No.: US 2023/0387515 A1
(43) Pub. Date: Nov. 30, 2023

(54) Battery Cell Having a Plurality of Electrode Units in a Common Battery Cell Housing

(71) Applicant: Bayerische Motoren Werke Aktiengesellschaft, Muenchen (DE)

(72) Inventors: Sonia DANDL, Muenchen (DE); Franz FUCHS, Muenchen (DE); Simon LUX, Muenster (DE); Sebastian SCHARNER, Tuerkenfeld (DE)

(21) Appl. No.: 18/030,791

(22) PCT Filed: Aug. 19, 2021
(86) PCT No.: PCT/EP2021/073022

§ 371 Date: Apr. 7, 2023

(30) Foreign Application Priority Data
Oct. 9, 2020 (DE) 10 2020 126 467.4

(51) Int. Cl. H01M 50/121; H01M 10/0525; H01M 50/133; H01M 50/124; H01M 50/103; H01M 50/134

(52) U.S. Cl. CPC H01M 50/121; H01M 10/0525; H01M 50/133; H01M 50/124; H01M 50/103; H01M 50/134; H01M 2220/20

(57) ABSTRACT

A battery cell has a plurality of electrode units in a common battery cell housing. Each of the electrode units includes a protective film having an inner layer and an outer layer, where the inner layer is arranged on the electrode unit and the outer layer is arranged on the inner layer. The outer layer has a higher melting point than the inner layer.

### BACKGROUND AND SUMMARY

The invention relates to a battery cell having a plurality of electrode units which are arranged in a common battery cell housing.

High-voltage batteries, which typically include one or more battery modules each having multiple battery cells, are used in electrically driven motor vehicles such as electric vehicles, hybrid vehicles, or plug-in hybrid vehicles. Due to the achievable high energy density, lithium-ion battery cells are used in particular in motor vehicles. The term “lithium-ion battery cell” is used here and hereinafter synonymously for all designations typical in the prior art for galvanic elements and cells containing lithium, such as lithium battery, lithium cell, lithium-ion cell, lithium polymer cell, and lithium-ion accumulator. In particular, rechargeable batteries (secondary batteries) are included. The lithium-ion battery cell can also be a solid-state battery cell, for example, a ceramic or polymer-based solid-state battery cell.

In the case of a mechanical impact on the battery cell, which causes, for example, a deformation and/or the penetration of a pointed object into the battery cell, or in the event of an overload of the battery cell, there can be the risk of overheating of the battery cell. Thermal runaway of the battery cell can occur due to exothermic electrode reactions, due, for example, to a short-circuit of the electrodes. At high temperatures, in particular, vaporization of the electrolyte contained in the battery cell can occur, due to which a critical overpressure arises in the battery cell. In a battery module having multiple battery cells, the thermal runaway of a battery cell can result in spreading of the overheating to the adjacent battery cells, so that there can be a risk of damage to the entire battery module or even the entire high-voltage battery if this is not prevented by suitable safety measures.

A battery cell having a hard-shell battery cell housing is known from document DE 10 2012 205 810 A1, in which multiple electrode units, which are each designed as a cell coil, are arranged in the hard-shell battery cell housing. With such an arrangement of multiple electrode units in a common housing, there can be the risk that thermal runaway of an electrode unit spreads in a very short time to the further electrode units arranged in the common housing.

It is an object of this disclosure to specify an improved battery cell having a plurality of electrode units in a common battery cell housing, in which the spreading of thermal runaway of an electrode unit to adjacent electrode units is prevented or at least slowed.

This object may be achieved by a battery cell according to the independent claim(s). Advantageous embodiments and refinements of the invention may result from the dependent claims.

According to one embodiment of the technology, the battery cell comprises a plurality of electrode units in a common battery cell housing. The electrode units are, for example, electrode stacks or electrode coils. The electrode stacks or electrode coils each in particular contain a layer sequence made up of anode and cathode layers, which are each separated from one another by a separator. The battery cell can in particular be a lithium-ion battery cell.

The battery cell is preferably a prismatic battery cell, which includes a solid battery cell housing, in which the multiple electrode units are arranged. The battery cell housing can have, for example, a rectangular footprint and can be essentially cuboid. Prismatic battery cells can advantageously be stacked easily and can be assembled to form a battery module. The battery cell housing can include, for example, a housing main body, which has a bottom wall and side walls, and a cover.

Each of the electrode units may be provided with a protective film in the battery cell. According to one embodiment, the protective film includes at least one inner layer and one outer layer. The inner layer is arranged on the electrode unit and the outer layer is arranged on the inner layer. The outer layer advantageously has a higher melting point than the inner layer. In other words, the protective film is embodied in at least two layers, wherein the outer layer has a greater thermal resistance than the inner layer. It is also possible that the protective film includes more than two layers, for example, three layers.

The technology is based in particular on the considerations described hereinafter: In the case of thermal runaway of an electrode unit, a large amount of energy can be released within seconds. This can have the result that electrolyte vaporizes and/or the active materials of the electrodes decompose. Furthermore, the separator between the electrodes can be damaged by the elevated temperature, due to which a large-area short-circuit of the electrodes can occur and all of the energy of the electrode unit may be discharged. This can result in a very strong pressure increase and the release of large amounts of energy in a very short time. This energy heats up the surroundings and can result in a critical temperature of adjacent electrode units being reached. At the critical temperature, for example at T_{crit}>150° C.-180° C., thermal runaway of the adjacent electrode unit can take place, due to which further energy is released. The energy can be emitted via side walls of the battery cell housing to further battery cells and thus can possibly damage further battery cells in a chain reaction. In the battery cell described in this disclosure, such a chain reaction is prevented or at least slowed by the protective film of the electrode units. In particular, a lower thermal conductivity of the protective film delays the energy emission of the electrode unit to adjacent electrode units. The total amount of energy emitted by the electrode unit during the thermal runaway does not change significantly in this way, but the total amount of energy is emitted to the surroundings at a reduced rate. This enables the heat dissipation via other paths, e.g., by cooling, via the cover, tie rods, etc., and thus reduces the amount of heat which is emitted via the side walls of the battery cell. In the best case, the effect is so strong that adjacent battery cells remain below the critical temperature and propagation of the thermal runaway is thus stopped. Even if the adjacent battery cell reaches the critical temperature, this takes place at a reduced rate, however. In a high-voltage battery of a motor vehicle comprising a plurality of battery cells, the risk of damage to the entire high-voltage battery is thus reduced.

The preferred at least two-layered embodiment of the protective film made up of an inner layer and an outer layer has the advantage that the outer layer can secure the thermal resistance of the protective film up to higher temperatures than if only the inner layer were present. A part of the energy can be absorbed by melting of the inner layer, while the outer layer remains thermally resistant.

The additionally provided inner layer can moreover be advantageous for the mechanical properties of the protective film. In particular, the inner layer can include a material having a lesser hardness than the outer layer. The softer inner layer can distribute the pressure onto the electrode unit better in this case and thus reduce the risk that the electrode unit will be damaged upon external pressure by the harder outer layer of the protective film.

In one preferred embodiment, the inner layer includes polypropylene (PP) or polyethylene (PE). The outer layer preferably includes a polyethylene terephthalate (PET), for example Mylar®, or a polyimide, for example Kapton®.

The protective film is preferably from 20 μm to 200 μm in thickness. The thickness of the protective film is to be understood as the total thickness of the layers of the multilayer protective film.

In one advantageous embodiment, the protective film includes multiple openings. The openings facilitate the penetration of the electrolyte into the electrode units. The openings in the protective film preferably face toward the bottom surface of the battery cell housing. The number of the openings is preferably from approximately 10 to 20.

The battery cell is preferably a lithium-ion battery cell. Lithium-ion battery cells are distinguished by a high energy density and are therefore suitable in particular for use in high-voltage batteries in motor vehicles.

Furthermore, a lithium-ion battery having a plurality of the battery cells described herein and a motor vehicle having the lithium-ion battery are proposed. The battery cell described herein, due to the improved level of safety, can advantageously be used in a lithium-ion battery, which can be used in particular as a traction battery in an electrically driven motor vehicle.

### BRIEF DESCRIPTION OF THE DRAWINGS

A preferred exemplary embodiment of the technology will be described hereinafter on the basis of the appended drawings. Further details, preferred embodiments, and refinements result therefrom.

FIG. 1 shows an exploded view of a battery cell according to one exemplary embodiment,

FIG. 2 shows a cross-sectional view of the electrode units,

FIG. 3 shows a top view of the protective film on the lower side of an electrode unit, and

FIG. 4 shows a cross-sectional view of an electrode unit.

Identical or identically acting components are each provided with the identical reference signs in the figures. The components shown and the size relationships of the components to one another are not considered to be to scale.

### DETAILED DESCRIPTION OF THE DRAWINGS

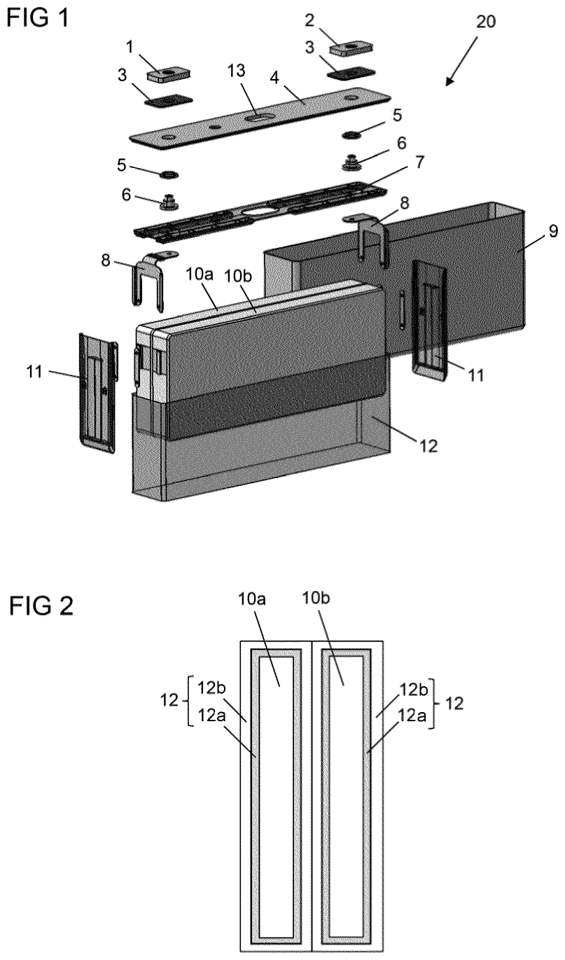

The battery cell 20 shown schematically in an exploded view in FIG. 1 is a prismatic battery cell 20. The battery cell 20 includes a battery cell housing, which is formed by a housing main body 9 and a cover 4. The battery cell housing forms a mechanically solid casing for the electrode units 10a, 10b arranged therein. Two electrode units 10a, 10b are arranged in the battery cell housing in the battery cell in the example shown. The electrode layers can be provided, for example, as a stack or coil (jellyroll) in the electrode units 10a, 10b. In the exemplary embodiment, the battery cell housing has a rectangular footprint and is essentially cuboid. The housing main body 9 and the cover 4 of the battery cell housing can be formed from a metal, for example aluminum. It is possible that the battery cell housing includes an electrically insulating coating at least in some areas.

The battery cell 20 includes a first terminal 1 and a second terminal 2, wherein the terminals 1, 2 are arranged on the cover 4 of the battery cell housing. The terminals 1, 2 are provided for electrically contacting the poles of the battery cell 20 and can each be electrically insulated from the cover 4 by an insulating plate 3. The terminals 1, 2 are each connected in the example shown by a rivet 6, which is led through the cover 4, to current collectors 8 of the electrode unit 10. Seals 5 are provided for sealing the feedthroughs through the cover 4. The electrode units 10a, 10b can be fixed in the battery cell housing by a holder 7, which is arranged between the electrode units 10 and the cover 4, and lateral holders 11.

An emergency venting opening 13 is arranged on the cover 4 of the battery cell housing. The emergency venting opening 13 is closed in the normal operation of the battery cell 20, for example by a bursting membrane. If the internal pressure in the battery cell 20 rises above a critical limit (typically between 6 bar and 15 bar), the bursting membrane opens so that the pressure can escape. The bursting membrane (not shown) can be fastened in the emergency venting opening 13 by laser welding, for example. The bursting membrane can have, for example, a thickness of 80 μm to 400 μm, preferably of 100 μm to 300 μm.

The electrode units 10a, 10b arranged in the battery cell each include a protective film 12. The protective film 12 advantageously essentially completely covers the electrode units 10a, 10b. “Essentially completely” can mean in particular that the film covers the electrode units except for possible openings for electrical feedthroughs and/or openings for the penetration of a liquid electrolyte.

A cross-sectional schematic view of the electrode units 10a, 10b is shown in FIG. 2. In the example shown, two electrode units 10a, 10b are arranged adjacent to one another. However, it is possible that the battery cell includes more than two electrode units, wherein the multiple electrode units can be interconnected in series or in parallel. The protective film 12 on the electrode units 10a, 10b is advantageously embodied in two layers. The protective film includes an inner layer 12a and an outer layer 12b. The outer layer 12b has the highest possible melting point, preferably of greater than 150° C. or even greater than 200° C. The outer layer 12b is provided in particular to ensure the thermal resistance of the protective film 12 in the event of a thermal runaway of an electrode unit 10a, 10b. The outer layer 12b preferably includes a polyethylene terephthalate, for example mylar, or a polyimide, for example Kapton®. The inner layer 12a can have a lower melting point than the outer layer 12b. If the melting point of the inner layer 12a is exceeded in the case of a thermal runaway of an electrode unit and the inner layer 12a is thus damaged, the outer layer 12b advantageously still remains intact for a longer time. The inner layer 12a is advantageously formed from a softer polymer than the outer layer 12b. The inner layer 12a can in particular improve the pressure distribution on the electrode units 10a, 10b. The inner layer 12a preferably includes polypropylene or polyethylene. The two-layer protective film 12 advantageously has a low thermal conductivity. The protective film reduces the heat transport between the adjacent electrode units 10a, 10b. In the event of a thermal runaway of an electrode unit, for example the electrode unit 10a, a thermal runaway of the adjacent electrode unit 10b is thus prevented or at least delayed. The heat resulting in the battery cell is thus released more slowly, so that the heat can be dissipated better, for example via the cover of the battery cell housing or a cooling. If a plurality of battery cells are arranged in a battery, damage to the entire battery is thus counteracted.

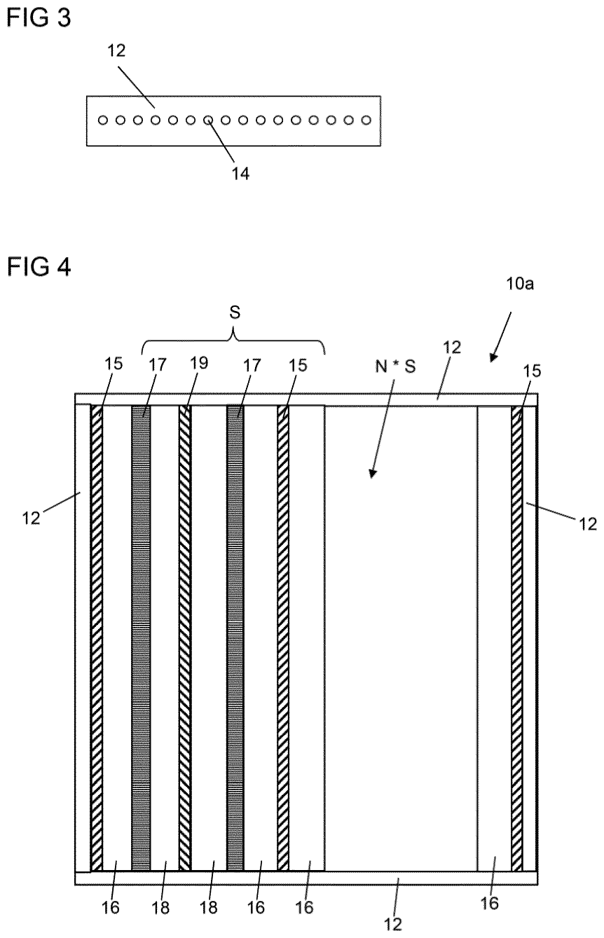

FIG. 3 shows a top view of an exemplary embodiment of the protective film 12 on a surface facing toward the bottom of the housing main body 9. The protective film 12 is advantageously perforated in this area. For example, the protective film 12 includes approximately 10 to 20 openings 14 in this area. The electrolyte can advantageously penetrate into the electrode units 10a, 10b through the openings 14 in the protective film 12 when the battery cell is filled with a liquid electrolyte.

FIG. 4 shows an example of the layer stack in an electrode unit 10a. The electrode unit 10a comprises copper foils 15, which are coated using an anode active material 16, and aluminum foils 19, which are coated using a cathode active material 18.

The anode active material 16 is, for example, a material from the group consisting of carbon-containing materials, silicon, silicon suboxide, silicon alloys, aluminum alloys, indium, indium alloys, tin, tin alloys, cobalt alloys, and mixtures thereof. The anode active material is preferably selected from the group consisting of synthetic graphite, natural graphite, graphene, meso-carbon, doped carbon, hard carbon, soft carbon, fullerene, silicon-carbon composite, silicon, surface-coated silicon, silicon suboxide, silicon alloys, lithium, aluminum alloys, indium, tin alloys, cobalt alloys, and mixtures thereof.

The cathode active material 18 can include a layered oxide such as a lithium-nickel-manganese-cobalt oxide (NMC), a lithium-nickel-cobalt-aluminum oxide (NCA), a lithium-cobalt oxide (LCO), or a lithium-nickel-cobalt oxide (LNCO). The layered oxide can in particular be an overlithiated layered oxide (OLO). Other suitable cathode active materials are compounds having spinel structure, such as lithium-manganese oxide (LMO) or lithium-manganese-nickel oxide (LMNO), or compounds having olivine structure, such as lithium-iron phosphate (LFP) or lithium-manganese-iron phosphate (LMFP).

The anode active material 16 is separated from the cathode active material 18 in each case by a separator 17. The separator 17 is in particular a film and includes a material which is permeable to lithium ions but impermeable to electrons. Polymers can be used as separators, in particular, a polymer selected from the group consisting of polyesters, in particular polyethylene terephthalate, polyolefins, in particular polyethylene and/or polypropylene, polyacrylonitriles, polyvinylidene fluoride, polyvinylidene hexafluoropropylene, polyether imide, polyimide, aramid, polyether, polyether ketone, synthetic spider silk, or mixtures thereof. The separator can optionally additionally be coated using ceramic material and a binder, for example based on Al₂O₃

A layer sequence S, which includes a copper foil 15 coated on both sides using the anode active material 16, an aluminum foil 19 coated on both sides using the cathode active material 18, and separators 17, can repeat multiple times in the electrode unit 10a (indicated in the drawing as N*S). A copper foil 15 coated using the anode active material 16 forms the terminus of the electrode unit 10a on both sides.

Although the invention was illustrated and described in detail on the basis of exemplary embodiments, the invention is not thus restricted by the exemplary embodiments. Rather, other variations of the invention can be derived therefrom by a person skilled in the art without leaving the scope of protection of the invention defined by the claims.

### LIST OF REFERENCE SIGNS

1 first terminal
2 second terminal
3 insulating plate
4 cover
5 seal
6 rivet
7 holder
8 current collector
9 housing main body
10 electrode unit
11 lateral holder
12 protective film
12a inner layer
12b outer layer
13 emergency venting opening
14 opening
15 copper foil
16 anode active material
17 separator
18 cathode active material
19 aluminum foil
20 battery cell

1-10. (canceled)

11. A battery cell comprising:
a plurality of electrode units in a common battery cell housing, each of the electrode units comprising:
a protective film thereon, the protective film including an inner layer and an outer layer, the inner layer being arranged on the electrode unit and the outer layer being arranged on the inner layer, wherein
the outer layer has a higher melting point than the inner layer.

12. The battery cell according to claim 11, wherein
the inner layer has a lower hardness than the outer layer.

13. The battery cell according to claim 11, wherein
the inner layer includes polyethylene or polypropylene.

14. The battery cell according to claim 11, wherein
the outer layer includes polyethylene terephthalate or polyimide.

15. The battery cell according to claim 11, wherein
the protective film is from 20 μm to 200 μm in thickness.

16. The battery cell according to claim 11, wherein
the protective film includes a plurality of openings for penetration of a liquid electrolyte into the electrode unit.

17. The battery cell according to claim 16, wherein
the plurality of openings are disposed in an area facing toward a bottom of the battery cell housing.

18. The battery cell according to claim 16, wherein
a number of the openings is from 10 to 20.

19. The battery cell according to claim 11, wherein
the battery cell is a lithium-ion battery cell.

20. A lithium-ion battery comprising a plurality of the battery cells according to claim 19.

21. A motor vehicle comprising the lithium-ion battery according to claim 20.
